(19) United States
(12) Patent Application Publication
(10) Pub. No.: US 2026/0103268 A1
(43) Pub. Date: Apr. 16, 2026

(54) GYROSTABILISER WITH ACTIVE PRECESSION CONTROL AND ENERGY RECUPERATION SYSTEM

(71) Applicant: VEEM LTD, Canning Vale (AU)

(72) Inventor: Andrey Vladimirovich BEKKER, Canning Vale (AU)

(21) Appl. No.: 19/116,191

(22) PCT Filed: Sep. 27, 2023
(86) PCT No.: PCT/AU2023/050938

§ 371 Date: Mar. 27, 2025

(30) Foreign Application Priority Data
Sep. 27, 2022 (AU) 2022902801

(51) Int. Cl. B63B 39/04; B63B 35/44

(52) U.S. Cl. CPC B63B 39/04; B63B 35/44; B63B 2035/4466

(57) ABSTRACT

The disclosure relates to a system for precession control and/or energy recuperation in a gyrostabiliser, the system comprising: a gyrostabiliser having a flywheel mounted for rotation about a spin axis in a gimbal frame that is configured to be mounted in a vessel to be stabilised, wherein the gimble frame includes a precession shaft on which the gyrostabiliser rotates about an axis as the gyrostabiliser operates to stabilise the vessel; and an energy conversion arrangement operatively coupled to the precession shaft for converting the rotational movement of the precession shaft to electrical energy. The energy conversion arrangement is configured or adapted for operation in an energy generation mode when a precession rate of the gyrostabiliser is relatively high; e.g., in large wave conditions. The energy conversion arrangement is preferably configured for operation in one of two modes, including: (i) an energy generation mode for generating electrical energy from rotational movement of the precession shaft, and (ii) a braking mode for applying a braking force to the rotational movement of the precession shaft.

### CROSS REFERENCE TO RELATED APPLICATIONS

The present application is a U.S. National Phase of International Application No. PCT/AU2023/050938 entitled “GYROSTABILISER WITH ACTIVE PRECESSION CONTROL AND ENERGY RECUPERATION SYSTEM,” and filed on Sep. 27, 2023. International Application No. PCT/AU2023/050938 claims priority to Australian Patent Application No. 2022902801 filed on Sep. 27, 2022. The entire contents of each of the above-listed applications are hereby incorporated by reference for all purposes.

### TECHNICAL FIELD

The present disclosure relates to a gyrostabiliser with active precession control and an energy recuperation system, and especially to a system for recuperating energy and/or converting kinetic energy or movement of the gyrostabiliser to electrical energy.

The gyrostabiliser system of the disclosure will typically be designed for use in a marine vessel and it will be convenient to describe it in this exemplary context. It will be appreciated, however, that the system of the disclosure is not limited to that particular application and may be designed for use in other applications, such as in other fixed or floating structures, other vehicles, and/or camera mountings.

### BACKGROUND

The discussion of background art in this specification, including with reference to any documents, should in no way be considered an admission that such background art is well known or forms part of the common general knowledge in the field in Australia or in any other country.

The structure and operation of marine gyrostabiliser assemblies are generally quite well understood and these devices are gaining increasing adoption in commercial and recreational marine vessels. A gyrostabiliser assembly will typically comprise a spinning flywheel mounted in a gimbal frame that allows two of three possible rotational degrees of freedom, and the frame is rigidly mounted within the vessel. The specific manner in which the flywheel is constrained in its rotational motion allows the angular momentum of the spinning flywheel to combine with the flywheel's precession oscillation to generate large torques that vary with time to directly oppose a dynamic rolling motion of the vessel caused by wind and/or waves. Without any intervention, the vessel rolling motion combines with the flywheel angular momentum to cause oscillating precession motion. This then combines with the angular momentum to create a stabilising torque, which directly opposes undesirable rotational motion (e.g. wave-induced rolling motion) of the vessel. By arranging the gimbals in a specific way, a roll-stabilising device is created using the naturally occurring physics of gyro-dynamics which requires no further intervention to function. An example of a marine gyrostabiliser assembly is described in the present applicant's Australian patent application published as AU 2017216483 A1 and its international patent application published as WO 2021/174315 A1, the contents of both of which are incorporated herein in their entirety by direct reference.

Because, as noted above, the structure and operation of marine gyrostabilisers are generally quite well-understood, this specification does not aim to provide a detailed description of all of the components of a gyrostabiliser assembly, such as the flywheel, flywheel shaft, gimbal bearings, or the like. Rather, this specification directs the skilled reader to other publications for a description or explanation of those components.

While seeking to optimise energy efficiency and operation of a gyrostabiliser, it has been found desirable to provide new ways and means for generating electricity from the movement of a gyrostabiliser.

### SUMMARY

According to one broad aspect, the disclosure provides a system for controlling precession of a gyrostabiliser and/or for energy recuperation from a gyrostabiliser, the system comprising: a gyrostabiliser having a flywheel mounted for rotation about a spin axis in a gimbal frame and configured to be mounted in a vessel to be stabilised, wherein the gimble frame includes a precession shaft on which the gyrostabiliser rotates about a precession axis as the gyrostabiliser operates to stabilise the vessel; and a precession control arrangement that is operatively coupled to the precession shaft, and which recuperates or converts kinetic energy or rotational movement of the precession shaft, preferably into electrical energy or hydraulic energy.

In this way, the gyrostabiliser is allowed to precess and the induced precession torque is used to drive the precession control system and/or the energy recuperation or energy conversion system. In the typical case of the gyrostabiliser being deployed in a marine vessel, the waves that excite or move the vessel form the energy source that forces the gyrostabiliser to rotate in the precession axis, and this precession torque does useful work over a range of precession angles. With the present disclosure, this work done in the precession axis can be converted to electrical energy by a suitable conversion arrangement. At the same time, the recuperation of the energy from the precession movement of the gyrostabiliser can be used to actively control or regulate the degree or extent of precession.

In an embodiment, the precession control system and/or energy recuperation system is configured or adapted for operation in an energy generation mode when a precession rate of the gyrostabiliser is relatively high; e.g., in large wave conditions.

In an embodiment, the precession control system and/or energy recuperation system is configured to operate in at least one of two modes, including (i) an energy recuperation mode for generating electrical energy from rotational movement of the precession shaft, and (ii) a driving mode for applying a torque for rotational movement of the precession shaft, i.e., to deliver torque to the precession shaft and thereby actively to drive the gyrostabiliser. This latter mode is of benefit in small waves as the gyrostabiliser is then able to produce a better stabilisation in low waves.

Previous work in this field has shown that gyroscopes used to harvest energy in this fashion are not well-suited as stabilising devices (e.g., in the roll axis of a marine vessel). In this regard, it is usually necessary for the gyrostabiliser to be exposed to high induced precession torques and to precess rapidly in order to generate enough energy to overcome the losses in the flywheel spin axis (bearing torques). However, the high precession torques are only generated or induced when the vessel roll rates are high, resulting in a lower stabilisation effect. As a result, the vessel will tend to roll more than desirable if the system is to harvest the wave energy. Accordingly, there is an inherent tension and trade-off to be resolved between stabilisation, on the one hand, and energy recuperation or energy generation, on the other hand. This tension may thus result in two operating modes, namely: a stabilising mode and an energy generating mode. For example, when passengers are onboard the marine vessel, the gyrostabiliser can be switched to a stabilising mode, and when the vessel is unoccupied it could be switched to an energy-generating mode. This could be achieved by varying the rotational speed of the flywheel in the gyrostabiliser and adjusting to suit the preference of the user. The adjustment of rotational speed (rpm) of the flywheel to change between stabilising and energy harvesting is a new approach. The design of the control system to enable this is non-trivial. Previously, work in this field focussed on either maximising stabilisation or maximising energy generation. However, the system of the present disclosure that can switch between either mode provides a new approach.

In an embodiment, the energy conversion arrangement comprises an electric motor (i.e., operable as a generator) having a motor shaft that is operatively coupled to the precession shaft to be driven by rotational movement of the precession shaft. That is, the electric motor is mechanically coupled to the precession output shaft. A reduction gearing is provided between the motor shaft and the precession shaft for converting high precession torque and a relatively slow precession rate to high motor shaft rotation rate and lower motor shaft torque. For example, while the gyrostabiliser might precess at a peak rate of 35 rpm, an optimal spin rate for the motor might be 3500 rpm. In this example, a reduction gear of 100:1 would then be required. Smaller gyrostabilisers may require faster motors and higher reduction-ratio gears. Larger gyrostabilisers may use motors with more poles and thus be able to spin at slower rates with smaller reduction-ratio gears. The reduction gearing might, for example, comprise a simple pair of spur gears of different diameters, or a planetary system of gears.

In an embodiment, the electric motor is efficient and capable of providing torque in either direction of shaft rotation (i.e., clockwise & anticlockwise) and also regenerating energy from shaft rotation in either direction. The electric motor may be a permanent magnet alternating current (PMAC) motor (aka a brushless DC motor). Alternatively, it may be an induction-style motor or a switched-reluctance motor. The motor geometry may utilise axial flux or radial flux.

By utilising an electric motor, several new advantages are obtained. Firstly, the precession range of the gyrostabiliser is able to be increased to about ±90° (compared to hydraulic systems which are typically limited to about ±70° range). This enables more stabilising torque to be created for a given angular momentum. Secondly, the electric motor and motor drive (i.e., speed controller, Variable Speed Drive, Variable Frequency Drive) will be capable of four quadrant operation (i.e., braking/generating operation or driving operation, for shaft rotation in both directions-clockwise and anti-clockwise), so it will be able to deliver torque to the precession axis and actively drive the gyrostabiliser for better stabilisation in small waves.

In an embodiment, the energy conversion arrangement comprises a hydraulic circuit operatively coupled to the precession shaft to transfer energy from rotational movement of the precession shaft to hydraulic energy. The hydraulic circuit includes at least one hydraulic cylinder coupled to the precession shaft for converting rotational movement of the precession shaft to axial movement of a piston in the hydraulic cylinder to generate hydraulic pressure. Preferably, the hydraulic circuit includes at least two hydraulic cylinders coupled to the precession shaft for converting movement of the precession shaft in either direction about the precession axis. The hydraulic cylinders are preferably connected in the hydraulic circuit via a four check-valve rectifier. In this version of the energy conversion arrangement, hydraulic cylinders are used to control the precession motion.

It will be appreciated that the term “gyrostabiliser” as it is used throughout this document is understood as referring to a gyrostabiliser apparatus or gyrostabiliser unit or “gyrostabiliser assembly” which may be incorporated or installed in a vehicle, such as a marine vessel, or in some other device subject to undesirable rotational motions (like a wave-induced rolling motion) in order to counteract and/or reduce such undesirable motions.

### BRIEF DESCRIPTION OF THE DRAWINGS

For a more complete understanding of the invention and advantages thereof, exemplary embodiments of the invention are explained in more detail in the following description with reference to the accompanying drawing figures, in which like reference signs designate like parts and in which:

FIG. 1 is a schematic partially cross-sectional view of a vacuum chamber assembly in a gyrostabiliser assembly;

FIG. 2 is a schematic diagram of a precession shaft of a gyrostabiliser in mechanical coupling with a shaft of an electric motor/generator in an embodiment of the system of the disclosure;

FIG. 3 is a schematic diagram illustrating the four quadrants of operation of the system of the disclosure according to an embodiment of the disclosure;

FIG. 4 is a schematic diagram illustrating the variation in stabilisation effect and energy generation with variation in flywheel spin speed for a gyrostabiliser;

FIG. 5 is a schematic diagram illustrating variation in energy generation with variation in precession angle and precession rate for a gyrostabiliser; and

FIG. 6 is a schematic illustration of a hydraulic circuit in an embodiment of the energy conversion system of the disclosure.

The accompanying drawings are included to provide a further understanding of the present invention and are incorporated in and constitute a part of this specification. The drawings illustrate particular embodiments of the invention and, together with the description, serve to explain the principles of the invention. Other embodiments of the invention and many of the attendant advantages will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. Furthermore, it will be noted that the elements of the drawings are not necessarily illustrated to scale relative to each other. It will also be understood that certain actions or steps in an embodiment of a method may be described or depicted in a particular order of occurrences while those skilled in the art will understand that such specificity with respect to sequence is not actually required.

### DETAILED DESCRIPTION OF THE EMBODIMENTS

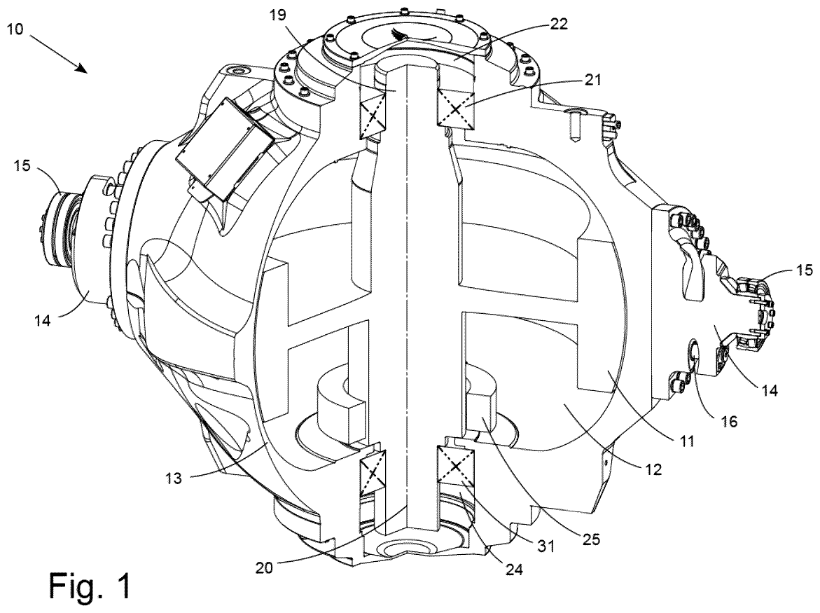

With reference initially to FIG. 1 of the drawings, a gyrostabiliser assembly with a vacuum chamber assembly 10 is illustrated schematically. The gyrostabiliser assembly includes a housing 13 that encloses a flywheel chamber 12 for supporting a partial vacuum V (e.g., in the range of about 1 to 100 mbar) as an operating pressure, and a flywheel 11 is housed in the flywheel chamber or the vacuum chamber 12 within the housing 13. The flywheel 11 may be mounted on, fixed to or (as shown) integrally formed with a flywheel shaft 19, which is, in turn, located relative to the housing 13 by an upper spin bearing 21 and a lower spin bearing 31 so that the flywheel 11 can rotate relative to the housing 13 about the spin axis 20, driven by a spin motor. The housing itself is pivotally mounted on precession stub shafts or axles 14 fixed to the housing 13, with precession bearings 15 shown fitted to the stub shafts or stub axles 14 to define a precession axis. The rotation of vacuum chamber assembly 10 around the precession axis is controlled by a precession control system 1, as will be described below.

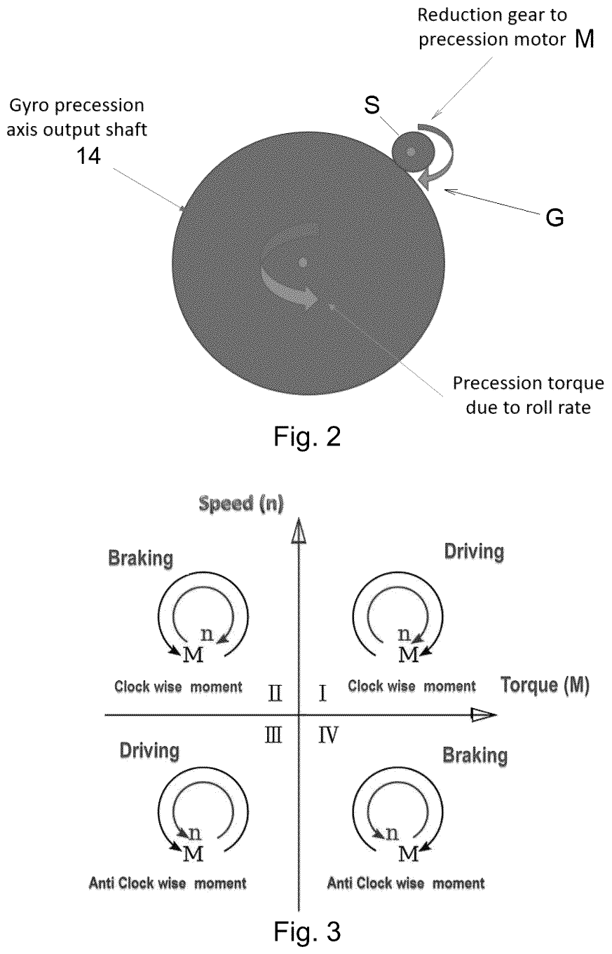

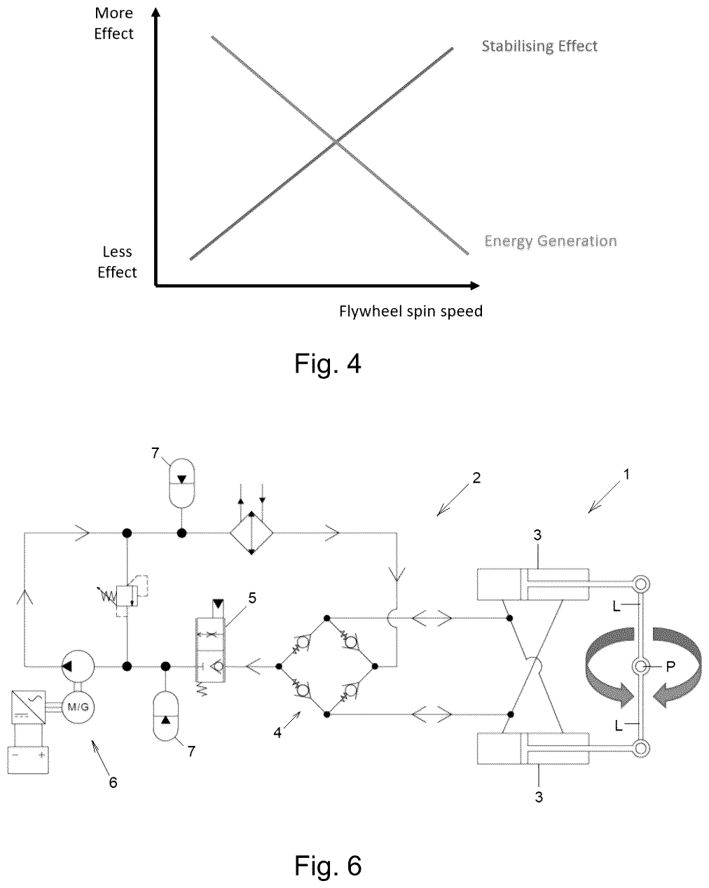

With reference to drawing FIGS. 2 to 5, a precession control and/or an energy recuperation system 1 of a first embodiment includes a shaft S of an electric motor/generator M mechanically coupled to a precession output shaft (e.g., stub shaft) 14 of the gyrostabiliser assembly. A high precession torque, coupled with a slow precession rate require a reduction gearing G between the two shafts S, 14. This allows for a low torque and high rotation rate in the electric motor M, as schematically shown in FIG. 1.

While the gyrostabiliser might precess at a peak rate of just 35 rpm, the optimal spin rate for the motor M might be 3500 rpm. In such a case, reduction gearing of 100:1 would be required. Smaller gyrostabilisers may require motors with a higher speed and thus require higher reduction-ratio gearing. Larger gyrostabilisers may use motors with more poles and thus be able to spin at slower rates with smaller reduction-ratio gearing. The gearing could be a simple pair of spur gears of different diameters, or it could be a planetary system of gears. A range of different gearing configurations is contemplated. The electric motor M is efficient and capable of providing torque in either rotary direction (clockwise & anticlockwise) as well as providing regenerating energy via its output shaft in both directions. It may be a permanent magnet alternating current (PMAC) motor (aka a brushless DC motor). Alternatively, it may be an induction-style or switched-reluctance motor. The motor geometry may utilise axial flux or radial flux.

By utilising an electric motor several advantages are gained. The precession range is able to be increased out to ±90°, which enables more stabilising torque to be created for a given angular momentum. Further, the electric motor and motor drive (aka speed controller/Variable Speed Drive/Variable Frequency Drive) is capable of the four quadrant operation shown in FIG. 3, so it will be able to deliver torque to the precession shaft 14 and actively drive the gyrostabiliser in small waves. This is beneficial as the gyrostabiliser will be able to produce a better stabilisation in low waves. As discussed above, there is an inherent tension and trade-off to be resolved between stabilisation and energy generation. This tension results in two operating modes in this disclosure, namely: a stabilising mode and an energy recuperating/energy generating mode. For example, when passengers are onboard the marine vessel, the gyrostabiliser can be switched to the stabilising mode, and when vessel is unoccupied it could be switched to the energy-generating mode. This may be achieved by varying a rotational speed of the flywheel in the gyrostabiliser and adjusting to suit the preference of the user.

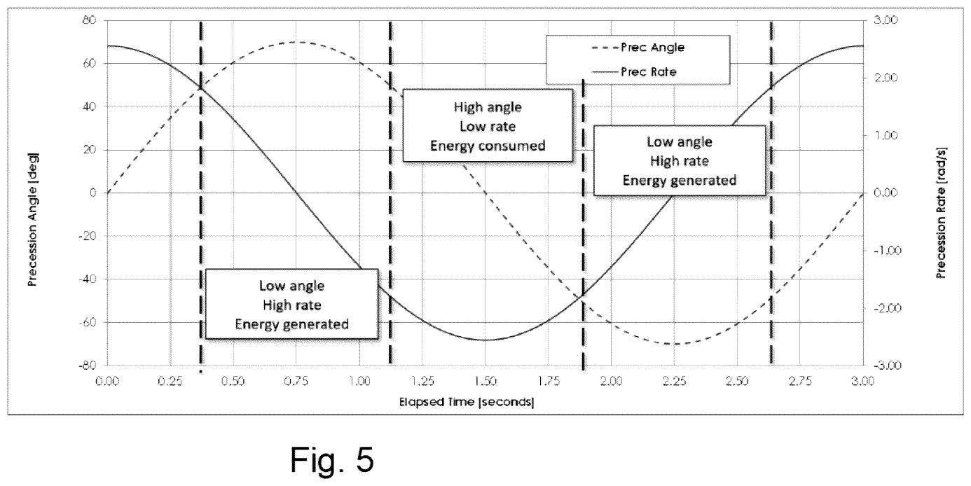

At low precession speed, the ability to harvest/generate electrical energy is low and thus the applied regenerative braking torque is low. To maintain effective control of the gyrostabiliser and prevent unwanted impacts, the precession control system may be required to consume energy by creating a high opposing torque. Thus, system may be configured to change from generating energy to consuming energy. The largest amount of work done in the precession axis (due to induced precession torque) occurs in the middle of the precession range when the gyrostabiliser is precessing at its fastest rate. This is a favourable outcome as it means the regenerative braking will be working well in this area, as illustrated in FIG. 5 of the drawings. It is the low precession speed (and zero speed) case(s) where the regenerative braking system will have limited impact and an alternative method of controlling the gyrostabiliser's precession motion will be needed. A mechanical brake or locking pin may, for example, be employed in some instances.

With reference to FIG. 6 of the drawings, a precession control and/or energy recuperation system 1 of a second embodiment is illustrated. In this embodiment, a hydraulic circuit 2 includes two hydraulic cylinders 3 which are connected by mechanical linkages L that are used to control the precession motion. The movement of pistons in the hydraulic cylinders 3 causes fluid to flow out of the cylinders 3 and into a main or primary manifold 4. The manifold 4 uses four check-valves to rectify the flow in a single direction as shown (i.e., despite the fact that precession motion at precession shaft 14 is oscillating and alternating in direction). The flow out of the rectification circuit 4 first passes over a control valve 5 for normal braking operations. Downstream of the control valve 5 is a hydraulic motor 6 (with a pump head coupled to an electric motor M). The electric motor/drive combination is capable of four-quadrant operation as per the previous embodiment. (See FIG. 3). The hydraulic motor 6 can then absorb/recuperate energy from the hydraulic fluid flow by regeneratively braking the flow. Alternatively, the hydraulic motor 6 can be used to boost the flow rate in order to assist the gyrostabiliser to precess in small waves; in this mode, the motor will be consuming energy. A series of accumulators 7 may be deployed to assist with reducing flow/pressure pulses that can result from rectifying the sinusoidal fluid flow generated by the oscillating or alternating precession motion.

The system 1 in this embodiment will need to have several operating modes. In small waves, with a low induced precession torque, it may be necessary to constantly drive the hydraulic motor 6 and consume energy in order to increase the precession motion (and thus a stabilising effect) of the gyrostabiliser. The control valve V will be fully open in this mode to minimise pressure drop in the circuit. In medium waves, the hydraulic motor 6 of the system will alternate between supplying and recovering energy from the gyrostabiliser. In the middle of the precession motion, the precession rate will be highest and the motor 6 will be braking and generating electrical energy. At the ends of the precession motion, the hydraulic motor 6 will consume electrical energy to boost the precession motion. In large waves, the hydraulic motor 6 will constantly be opposing the precession motion of the gyrostabiliser and thus constantly be regenerating energy. The control valve V will start to intervene in this mode, i.e., when the braking pressure generated by the hydraulic motor 6 is saturated.

The hydraulic system 1 of this embodiment in FIG. 6 can thus both generate energy and also drive motion in the precession axis. Using a suitable hydraulic control system that is assisted by accumulators 7 as shown in the circuit of FIG. 6 allows the pulsing flow of the gyrostabiliser to be smoothed out. This can produce a consistent energy generation during braking operations. Alternatively, if the system 1 requires some excitation input to the precession axis, this combination of hydraulic components can readily be used to actively drive the precession motion.

It has been identified that the motion of the gyrostabiliser should be controlled by specifying the allowable rate of precession for every point in the precession range. This is able to be achieved hydraulically by using a pressure-compensated flow control valve. In the present disclosure, the control strategy is adapted to allow the use of an electric motor. The control utilises a simple system whereby allowable precession rate is calculated at every time step. The torque input by the motor on the precession axis will adjust automatically using a PID loop to achieve the set speed. This methodology means that the wave system is not required to be known. The effect will be that, at high rates of precession, useful amounts of energy can be produced. However, at low rates it is likely that a smaller amount of energy will be consumed. A battery energy storage system can be used to assist with this, and the aim is to use the operating point where net energy is produced.

Although specific embodiments of the invention are illustrated and described herein, it will be appreciated by persons of ordinary skill in the art that a variety of alternative and/or equivalent implementations exist. It should be appreciated that each exemplary embodiment is an example only and is not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

Generally, the present disclosure is intended to cover any and all adaptations or variations of the specific embodiments discussed herein. By way of example, a skilled person will readily appreciate that the gyrostabiliser and the energy conversion systems of this disclosure are not limited to being made from any particular material described in specific embodiments. Rather, the skilled person will appreciate that a range of suitable materials exist, and the skilled person can readily select a suitable material based upon the known mechanical properties of that material which make it suitable for use in this disclosure. As the present disclosure involves engineering technology from a number of disciplines, it is expected that the notional ‘skilled person’ may comprise a group or a team of individuals having technical expertise and/or qualifications in one or more of the following fields or disciplines: mechanical engineering, electrical engineering, marine engineering, and hydraulic engineering.

It will also be appreciated that the terms “comprise”, “comprising”, “include”, “including”, “contain”, “containing”, “have”, “having”, and variations thereof used in this document are, unless the context indicates otherwise, intended to be understood in an inclusive (i.e. non-exclusive) sense, such that the process, method, device, apparatus, or system described herein is not limited to those features, integers, parts, elements, or steps recited but may include other features, integers, parts, elements, or steps not expressly listed and/or inherent to such process, method, device, apparatus, or system. Further, the terms “a” and “an” used herein are intended to be understood as meaning one or more unless explicitly stated otherwise. Moreover, the terms “first”, “second”, “third” etc. are used merely as labels and are not intended to impose any numerical requirements on or to establish any ranking of importance of their objects. In addition, reference to positional terms, such as “lower” and “upper”, used in the above description are to be taken in context of the embodiments depicted in the figures, and are not to be taken as limiting the invention to the literal interpretation of the term but rather as would be understood by the skilled addressee in the appropriate context.

1. A system for precession control in a gyrostabiliser, comprising:
a gyrostabiliser having a flywheel mounted for rotation about a spin axis in a gimbal frame configured to be mounted in a vessel to be stabilised, wherein the gimbal frame includes a precession shaft on which the gyrostabiliser rotates about an axis as the gyrostabiliser operates to stabilise the vessel; and
a precession control arrangement operatively coupled to the precession shaft for recuperating or converting kinetic energy or rotational movement of the precession shaft.

2. The system according to claim 1, wherein the precession control arrangement is configured for operation in an energy generation mode when a precession rate of the gyrostabiliser is relatively high, including in large wave conditions.

3. The system according to claim 1, wherein the precession control arrangement is configured for operation in at least one of two modes, including (i) an energy recuperation/energy generation mode for generating electrical energy from the rotational movement of the precession shaft, and (ii) a driving mode for applying a torque to the precession shaft.

4. The system according to claim 1, wherein the precession control arrangement comprises an electrical motor operable as a generator having a motor shaft that is operatively coupled to the precession shaft to be driven by rotational movement of the precession shaft.

5. The system according to claim 4, wherein reduction gearing is provided between the motor shaft and the precession shaft for converting high precession torque and a relatively slow precession rate to high motor shaft rotation rate and lower motor shaft torque.

6. The system according to claim 1, wherein the precession control arrangement comprises a hydraulic circuit operatively coupled to the precession shaft to transfer energy from rotational movement of the precession shaft to hydraulic energy.

7. The system according to claim 6, wherein the hydraulic circuit includes at least one hydraulic cylinder coupled to the precession shaft for converting rotational movement of the precession shaft to axial movement of a piston in the hydraulic cylinder to generate hydraulic pressure.

8. The system according to claim 7, wherein the hydraulic circuit includes at least two hydraulic cylinders coupled to the precession shaft for converting movement of the precession shaft in either direction about the precession axis, and wherein the hydraulic cylinders are connected in the hydraulic circuit via a four check-valve rectifier.

9. A system for recuperating energy from a gyrostabiliser, comprising:
a gyrostabiliser having a flywheel mounted for rotation about a spin axis in a gimbal frame configured to be mounted in a vessel to be stabilised, wherein the gimbal frame includes a precession shaft on which the gyrostabiliser rotates about an axis as the gyrostabiliser operates to stabilise the vessel; and
an energy conversion arrangement operatively coupled to the precession shaft for recuperating rotational movement of the precession shaft.

10. The system according to claim 9, wherein the energy conversion arrangement is configured for operation in an energy generation mode when a precession rate of the gyrostabiliser is relatively high including in large wave conditions.

11. The system according to claim 9, wherein the energy conversion arrangement is configured for operation in at least one of two modes, including (i) an energy generation mode for generating electrical energy from rotational movement of the precession shaft, and (ii) a driving mode for applying a torque to the precession shaft.

12. The system according to claim 9, wherein the energy conversion arrangement comprises an electrical motor operable as a generator having a motor shaft that is operatively coupled to the precession shaft to be driven by rotational movement of the precession shaft.

13. The system according to claim 12, wherein reduction gearing is provided between the motor shaft and the precession shaft for converting high precession torque and a relatively slow precession rate to high motor shaft rotation rate and lower motor shaft torque.

14. The system according to claim 9, wherein the energy conversion arrangement comprises a hydraulic circuit operatively coupled to the precession shaft to transfer energy from rotational movement of the precession shaft to hydraulic energy.

15. The system according to claim 14, wherein the hydraulic circuit includes at least one hydraulic cylinder coupled to the precession shaft for converting rotational movement of the precession shaft to axial movement of a piston in the hydraulic cylinder to generate hydraulic pressure.

16. The system-assembly according to claim 15, wherein the hydraulic circuit includes at least two hydraulic cylinders coupled to the precession shaft for converting movement of the precession shaft in either direction about the precession axis, wherein the hydraulic cylinders are connected in the hydraulic circuit via a four check-valve rectifier.

17. The system according to claim 9, wherein the energy conversion arrangement converts rotational movement of the precession shaft to electrical energy or hydraulic energy.
